(19) United States
(12) Patent Application Publication
(10) Pub. No.: US 2020/0081681 A1
(43) Pub. Date: Mar. 12, 2020

(54) MULITPLE MASTER MUSIC PLAYBACK

(71) Applicant: Spotify AB, Stockholm (SE)

(72) Inventor: Sten GARMARK, Stockholm (SE)

(21) Appl. No.: 16/126,770

(22) Filed: Sep. 10, 2018

(51) Int. Cl. G06F 3/16; G06F 3/0482; G06F 3/0488; G06F 16/61; G06F 16/64

(52) U.S. Cl. CPC G06F 3/165; G06F 3/0482; G06F 16/64; G06F 16/61; G06F 3/0488

(57) ABSTRACT

A method of providing a piece of music to a listener may involve determining a device the listener is using to listen to music and/or an environment in which the listener is listening to music, selecting a preferred master version of the piece of music from a collection of multiple master versions of the piece of music stored in a database, and providing the preferred master version of the piece of music on the device to the listener. In an alternative embodiment, the method may involve providing a list of multiple master versions of the piece of music to the listener, receiving a command from the listener, selecting a preferred master version from the list of multiple master versions, and providing the preferred master version of the piece of music to the listener.

### BACKGROUND

People listen to music using many different devices in many different environments. For example, music may be played via a home stereo system, headphones, ear buds, a car stereo, a smart phone, an MP3 player, a desktop or laptop computer, etc. Any of these devices may range in quality from extremely high end/high fidelity to extremely low quality. The music listener may also listen to music in virtually any location or during any activity, such as at home in a quiet room, in the car with a high level of background noise, in the office, while running outside, or engaging in virtually any other activity outdoors or indoors, in virtually any location with any number of different amounts and types of background noise and the like.

When music is recorded, it is typically mastered in a way to make the music sound good when it is played back on one type of hardware and in one environment. For example, today music is often mastered so that it will sound acceptable when played on relatively low quality ear buds in a relatively noisy environment, since many people listen to music that way. Unfortunately, that type of master version might make the music less enjoyable to listen to other, different scenarios, such as in a quiet music room at home, with a high fidelity sound system.

Mastering music so that it can be easily heard in noisy listening environments using low quality ear buds (for example) typically involves increasing the volume, or “loudness,” of the music in the recording. Recently, the trend in music mastering has been to increase the loudness of musical recordings, typically sacrificing dynamic qualities of the music in the process. This trend has been referred to as the “loudness war.” This type of high-volume mastering has been especially present since the advent of compact disc (CD) recording. When a CD is being recorded and maximum amplitude is reached, loudness can still be increased further via signal processing techniques, such as dynamic range compression and equalization. Unfortunately, modern recordings that use extreme dynamic range compression and other measures to increase loudness, can result in clipping and other audible distortion, thus sacrificing sound quality.

For example, some recordings of classical music have a very high dynamic range and must be listened to in a silent room for the listener to be able to hear both the quietest parts and also the loudest parts. If a listener tries to listen to such a recording in a car driving down the freeway, for example, the listener typically has to turn up the volume to hear the quietest parts and then turn the volume down for the loudest parts. This kind of constant volume adjustment detracts from the enjoyment of listening to music. Therefore, when such music is mastered, it may sometimes be compressed to reduce the difference between the loudest and quietest parts in the music or filtered to make the music sound better on a low quality radio and/or in noisy environments. Although this type of compressed and/or filtered master version may enhance the listening experience in a noisy car, it typically provides for a less satisfactory experience in a home listening studio. Unfortunately, there is usually only one master version of any given piece of music, album, etc., and thus the user does not have a choice.

### SUMMARY

In general terms, this disclosure is directed to media content playback with multiple different masters. In one possible configuration and by non-limiting example, multiple master versions of a piece of music may be made available to a listener, with each version corresponding to a different master version of the piece of music. In some embodiments, the listener may select the master, while in other embodiments the master may be automatically provided based on the listening environment and/or hardware being used to play the music. Various aspects are described in this disclosure, which include, but are not limited to, the following aspects.

In one aspect of the disclosure, a method of providing a piece of music to a listener may involve: determining at least one of a type of device the listener is using to listen to music or an environment in which the listener is listening to music; automatically selecting, based on the determining step, a preferred master version of the piece of music from a collection of multiple available master versions of the piece of music stored in a database; and providing the preferred master version of the piece of music to the listener on the device.

In some embodiments, the method may also involve displaying a list, to the listener, of the multiple available master versions of the piece of music. Optionally, the method may further involve receiving an override command from the user, designating a different one of the multiple available master versions, other than the preferred master version, and providing the different one of the multiple available master versions to the listener on the device. The list of the multiple available master versions may include, for example, mastered for high fidelity, mastered for binaural, mastered for 3D, mastered for on the go, mastered for travel, mastered for noisy environment, mastered for normal environment, or mastered for quiet environment, mastered for ear buds, mastered for high fidelity headphones, mastered for car stereo, mastered for outdoor activities, mastered for high compression, mastered for low compression and/or the like. Optionally, the method may also include displaying, near a title of the piece of music, a display indicating that multiple master versions of the piece of music are available.

In some embodiments, the determining step may involve listening to the environment in which the listener is listening to music using a microphone on or near the device to determine how noisy the environment is. In these or other embodiments, the determining step may also involve capturing an image of the environment in which the listener is listening to music using a camera on or near the device to determine what type of environment the environment is. The determining step may additionally or alternatively include determining whether digital information is available describing the device. The determining step may also include determining that the device has been connected with headphones, and in that case, the selected preferred master version may be mastered for binaural or mastered for 3D.

Some embodiments may also involve switching from the preferred master version to a different master version during playback of the piece of music, based on the environment changing during the playback. Such an embodiment may further include switching back to the preferred master version during playback of the piece of music, based on the environment changing again.

The method may also involve receiving the collection of multiple available master versions from a provider of music and storing the collection in memory on a server. The method may also involve receiving a single original master version of the piece of music from a provider of music, generating the collection of multiple available master versions from the single original master version, and storing the collection in memory on a server. Optionally, such an embodiment may further involve receiving a configuration file from the provider of music, where the configuration file includes data describing a method for generating the collection of multiple master versions from the single original master version, and where the generating step includes using the configuration file to generate the collection of multiple master versions.

In another aspect of the disclosure, a method of providing a piece of music to a listener may involve providing a list of multiple master versions of the piece of music to the listener, wherein the multiple master versions are stored in a database, receiving a first command from the listener, selecting a first master version from the list of multiple master versions, and providing the first master version of the piece of music to the listener. The method may further involve displaying, near a title of the piece of music, a display indicating that multiple master versions of the piece of music are available. The method may also optionally involve receiving a second command from the listener, selecting a second master version from the list of multiple master versions, and providing the second master version of the piece of music to the listener. In some cases, the second master version may be selected and provided during playback of the piece of music.

In another aspect of the present disclosure, a media playback device may include an audio output device for media playback, a touch-sensitive display, a processor and a computer-readable storage device storing data instructions, which, when executed by the processor, cause the processor to perform a number of steps. For example, the instructions may cause the processor to display a list of multiple master versions of a piece of music to a listener on the touch-sensitive display, receive an instruction from the listener, selecting a first master version of the multiple master versions for playback on the device, and play the first master version of the piece of music on the media playback device.

In some embodiments, the instructions further cause the processor to determine an environment in which the listener is listening to music, automatically select, based on the determining step, a second master version of the multiple master versions, and provide the second master version of the piece of music on the media playback device to the listener. In some embodiments, the second master version is provided to the listener on the touch-sensitive display as a suggested alternative master version. In some embodiments, the instructions may further cause the processor to switch from the second master version to the first master version or a third master version during playback of the piece of music, based on the environment changing during the playback. The instructions may further cause the processor to switch back to the second master version during playback of the piece of music, based on the environment changing again.

In some embodiments, the instructions may further cause the processor to display a list, on the touch-sensitive display, of the multiple available master versions of the piece of music. Optionally, the instructions may further cause the processor to display, near a title of the piece of music, a display indicating that multiple master versions of the piece of music are available. The instructions may also cause the processor to receive an instruction from the listener via an entry on the touch-screen display.

These and other aspects and embodiments are described in greater detail below, in reference to the attached drawing figures.

### BRIEF DESCRIPTION OF THE DRAWINGS

FIG. 1 illustrates an example media-playback system for media content playback during travel;

FIG. 2 is a schematic illustration of the example media-playback system of FIG. 1;

FIG. 3 illustrates a method of providing multiple master versions of a song to a user, according to one embodiment;

FIG. 4 illustrates a method of providing multiple master versions of a song to a user, according to an alternative embodiment;

FIG. 5 is a schematic diagram of an interface on a smart phone, displaying a song title and an indication that multiple master versions of the song are available, according to one embodiment;

FIG. 6 is a schematic diagram of an interface on a smart phone, displaying a song title and multiple master versions of the song, according to one embodiment;

FIG. 7 is a diagram illustrating an overall music delivery system and data flow;

FIG. 8 illustrates one exemplary embodiment of a master generation method; and

FIG. 9 illustrates an example of a music upload user interface.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

As discussed above, people listen to music using many different devices in many different environments, but they typically only have one recorded version of the song to listen to. Methods and systems described below allow a listener to select a preferred master version of a song from a list of multiple masters, automatically provide a listener with a preferred master version, or allow for some combination of both.

Consuming media content may include listening to audio content, watching video content and/or consuming other types of media content. For ease of explanation, the embodiments described in this application are presented using specific examples. For example, audio content (and in particular music) is described as an example of one form of media consumption. As another example, travelling (and in particular driving) is described as one example of an activity during which media content is consumed. However, the same concepts are similarly applicable to other forms of media consumption and to other activities, and at least some embodiments include other forms of media consumption and/or are configured for use during other activities.

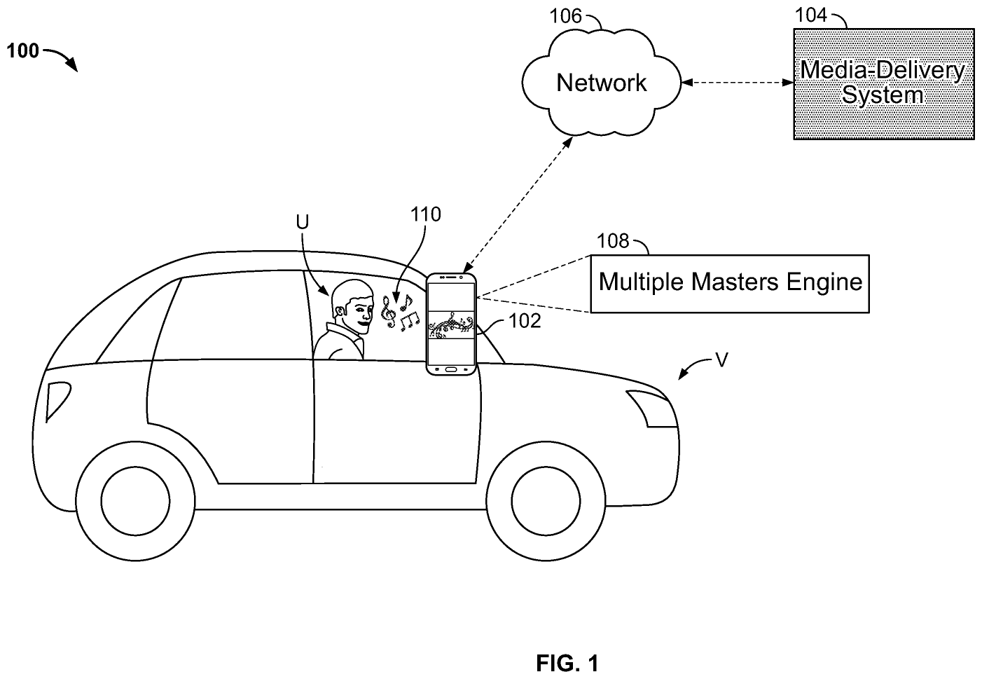

FIG. 1 illustrates an example media-playback system 100 for media content playback during travel. The example system 100 includes a media-playback device 102 and a media-delivery system 104. The media-playback device 102 includes a multiple masters engine 108. The system 100 communicates across a network 106. Also shown, is a user U who is travelling in a vehicle V. Although the system 100 is illustrated here with the media-playback device 102, the illustrated system 100 is but one example of a media-playback system, and media-playback device 102 is but one example of a media-playback device. Indeed, the multiple masters methods and systems described herein may be applied to virtually any media playback system and device, such as but not limited to a car stereo system, a smart phone, a home entertainment system, a home stereo system, a laptop or desktop computer, a tablet computing device, headphones, ear buds and the like.

The media-playback device 102 plays back media content items to produce media output 110. In some embodiments, the media content items are provided by the media-delivery system 104 and transmitted to the media-playback device 102 using the network 106. A media content item is an item of media content, including audio, video, or other types of media content, which may be stored in any format suitable for storing media content. Non-limiting examples of media content items include songs, albums, audiobooks, music videos, movies, television episodes, podcasts, other types of audio or video content, and portions or combinations thereof.

The media-playback device 102 plays media content for the user during travel or other activities. The media content that is played back may be selected based on user input or may be selected without user input. For example, as described further below, a master version of a piece of music may be selected from a collection of multiple master versions stored in a database, and this selection may be automatic in some embodiments and manual in others. The media content may be selected for playback without user input by either the media-playback device 102 or the media-delivery system 104. For example, media content can be selected for playback without user input based on stored user profile information, listening environment, what type of media-playback device is being used, location, travel conditions, current events, and other criteria. User profile information includes but is not limited to user preferences and historical information about the user's consumption of media content, such as types of master versions selected by the user for listening in the past. User profile information can also include libraries and/or playlists of media content items associated with the user. User profile information can also include information about the user's relationships with other users (e.g., associations between users that are stored by the media-delivery system 104 or on a separate social media site). Although the media-playback device 102 is shown as a separate device in FIG. 1, the media-playback device 102 can also be integrated with the vehicle (e.g., as part of a dash-mounted vehicle infotainment system), or as mentioned above, the media-playback device 102 may be any suitable device, not necessarily used in a car or for travel.

The multiple masters engine 108 allows for the selection of a preferred master version of a piece of music from a collection of multiple master versions. In various embodiments, the selection of a master from a list or collection of masters can be automatic, manual or a hybrid of automatic and manual. The multiple masters engine 108 may also generate interfaces for selecting and playing back master versions of a piece of music. Embodiments of the multiple masters engine 108 are illustrated and described further throughout.

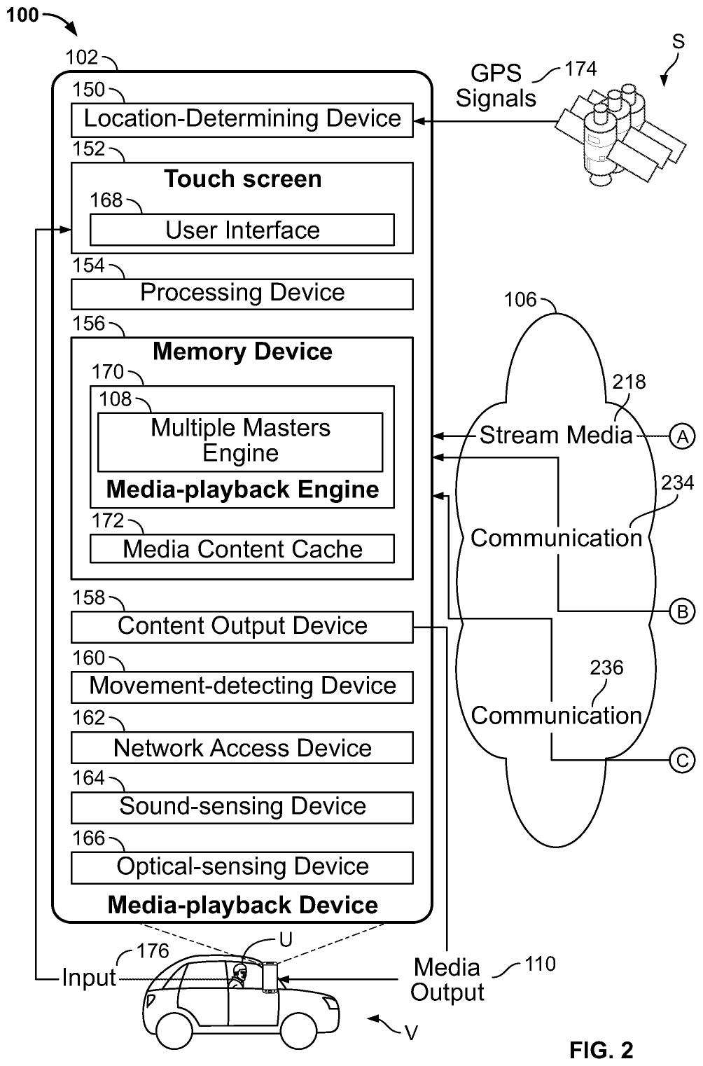

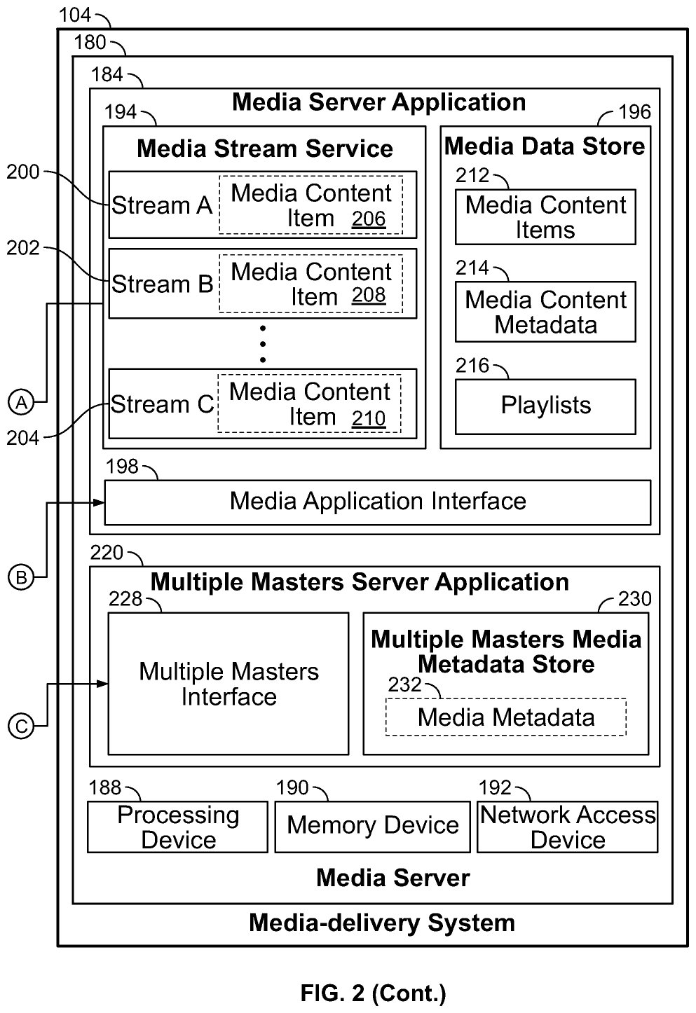

FIG. 2 is a schematic illustration of an example system 100 for media content playback during travel. In FIG. 2, the media-playback device 102, the media-delivery system 104, and the network 106 are shown. Also shown are the user U in the vehicle V, and satellites S.

As noted above, the media-playback device 102 plays media content items. In some embodiments, the media-playback device 102 plays media content items that are provided (e.g., streamed, transmitted, etc.) by a system external to the media-playback device, such as the media-delivery system 104, another system, or a peer device. Alternatively, in some embodiments, the media-playback device 102 plays media content items stored locally on the media-playback device 102. Further, in at least some embodiments, the media-playback device 102 plays media content items that are stored locally, as well as media content items provided by other systems.

In various embodiments, the media-playback device 102 may be a computing device, handheld entertainment device, smartphone, tablet, watch, wearable device, or any other type of device capable of playing media content. In yet other embodiments, the media-playback device 102 is an in-dash vehicle computer, laptop computer, desktop computer, television, gaming console, set-top box, network appliance, blue-ray or DVD player, media player, stereo, or radio.

In at least some embodiments, the media-playback device 102 includes a location-determining device 150, a touch screen 152, a processing device 154, a memory device 156, a content output device 158, a movement-detecting device 160, a network access device 162, a sound-sensing device 164, and an optical-sensing device 166. Other embodiments may include additional, different, or fewer components. For example, some embodiments do not include one or more of the location-determining device 150, the touch screen 152, the sound-sensing device 164, and the optical-sensing device 166.

The location-determining device 150 is a device that determines the location of the media-playback device 102. In some embodiments, the location-determining device 150 uses one or more of the following technologies: Global Positioning System (GPS) technology, which may receive GPS signals 174 from satellites S, cellular triangulation technology, network-based location identification technology, Wi-Fi positioning systems technology, and combinations thereof.

The touch screen 152 operates to receive an input 176 from a selector (e.g., a finger, stylus, etc.) controlled by the user U. In some embodiments, the touch screen 152 operates as both a display device and a user input device. In some embodiments, the touch screen 152 detects inputs based on one or both of touches and near-touches. In some embodiments, the touch screen 152 displays a user interface 168 for interacting with the media-playback device 102. As noted above, some embodiments do not include a touch screen 152. Some embodiments include a display device and one or more separate user interface devices. Further, some embodiments do not include a display device.

In some embodiments, the processing device 154 comprises one or more central processing units (CPU). In other embodiments, the processing device 154 additionally or alternatively includes one or more digital signal processors, field-programmable gate arrays, or other electronic circuits.

The memory device 156 operates to store data and instructions. In some embodiments, the memory device 156 stores instructions for a media-playback engine 170 that includes the multiple masters engine 108. In some embodiments, the media-playback engine 170 selects and plays back media content and generates interfaces for selecting and playing back media content items. The multiple masters engine 108 may also generate interfaces for selecting and playing back media content items.

Some embodiments of the memory device also include a media content cache 172. The media content cache 172 stores media content items, such as media content items that have been previously received from the media-delivery system 104. The media content items stored in the media content cache 172 may be stored in an encrypted or unencrypted format. The media content cache 172 can also store decryption keys for some or all of the media content items that are stored in an encrypted format. The media content cache 172 can also store metadata about media content items, such as title, artist name, album name, length, genre, mood, era, etc. The media content cache can also store multiple master versions of a piece of music and/or metadata identifying multiple available master versions of the piece of music. The media content cache 172 can also store playback information about the media content items, such as the number of times the user has requested to playback the media content item or the current location of playback (e.g., when the media content item is an audiobook, podcast, or the like for which a user may wish to resume playback).

The memory device 156 typically includes at least some form of computer-readable media. Computer readable media includes any available media that can be accessed by the media-playback device 102. By way of example, computer-readable media include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory and other memory technology, compact disc read only memory, blue ray discs, digital versatile discs or other optical storage, magnetic cassettes, magnetic tape, magnetic disk storage or other magnetic storage devices, or any other medium that can be used to store the desired information and that can be accessed by the media-playback device 102. In some embodiments, computer readable storage media is non-transitory computer readable storage media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The content output device 158 operates to output media content. In some embodiments, the content output device 158 generates media output 110 for the user U that is directed into an interior cabin of the vehicle V. Examples of the content output device 158 include a speaker assembly comprising one or more speakers, an audio output jack, a Bluetooth transmitter, a display panel, and a video output jack. Other embodiments are possible as well. For example, the content output device 158 may transmit a signal through the audio output jack or Bluetooth transmitter that can be used to reproduce an audio signal by a connected or paired device such as headphones, speaker system, or vehicle head unit.

The movement-detecting device 160 senses movement of the media-playback device 102. In some embodiments, the movement-detecting device 160 also determines an orientation of the media-playback device 102. In at least some embodiments, the movement-detecting device 160 includes one or more accelerometers or other motion-detecting technologies or orientation-detecting technologies. As an example, the movement-detecting device 160 may determine an orientation of the media-playback device 102 with respect to a primary direction of gravitational acceleration. The movement-detecting device 160 may detect changes in the determined orientation and interpret those changes as indicating movement of the media-playback device 102. The movement-detecting device 160 may also detect other types of acceleration of the media-playback device and interpret those acceleration as indicating movement of the media-playback device 102 too.

The network access device 162 operates to communicate with other computing devices over one or more networks, such as the network 106. Examples of the network access device include one or more wired network interfaces and wireless network interfaces. Examples of wireless network interfaces include infrared, BLUETOOTH® wireless technology, 802.11a/b/g/n/ac, and cellular or other radio frequency interfaces.

The network 106 is an electronic communication network that facilitates communication between the media-playback device 102 and the media-delivery system 104. An electronic communication network includes a set of computing devices and links between the computing devices. The computing devices in the network use the links to enable communication among the computing devices in the network. The network 106 can include routers, switches, mobile access points, bridges, hubs, intrusion detection devices, storage devices, standalone server devices, blade server devices, sensors, desktop computers, firewall devices, laptop computers, handheld computers, mobile telephones, vehicular computing devices, and other types of computing devices.

In various embodiments, the network 106 includes various types of links. For example, the network 106 can include wired and/or wireless links, including Bluetooth, ultra-wideband (UWB), 802.11, ZigBee, cellular, and other types of wireless links. Furthermore, in various embodiments, the network 106 is implemented at various scales. For example, the network 106 can be implemented as one or more vehicle are networks, local area networks (LANs), metropolitan area networks, subnets, wide area networks (such as the Internet), or can be implemented at another scale. Further, in some embodiments, the network 106 includes multiple networks, which may be of the same type or of multiple different types.

The sound-sensing device 164 senses sounds proximate the media-playback device 102 (e.g., sounds within a vehicle in which the media-playback device 102 is located). In some embodiments, the sound-sensing device 164 comprises one or more microphones. For example, the sound-sensing device 164 may capture a recording of sounds from proximate the media-playback device 102. These recordings may be analyzed by the media-playback device 102 using speech-recognition technology to identify words spoken by the user. The words may be recognized as commands from the user that alter the behavior of the media-playback device 102 and the playback of media content by the media-playback device 102. The words and/or recordings may also be analyzed by the media-playback device 102 using natural language processing and/or intent-recognition technology to determine appropriate actions to take based on the spoken words. Additionally or alternatively, the sound-sensing device may determine various sound properties about the sounds proximate the user such as volume, dominant frequency or frequencies, etc. These sound properties may be used to make inferences about the environment proximate to the media-playback device 102, such as whether the sensed sounds are likely to correspond to a private vehicle, public transportation, etc. In some embodiments, recordings captured by the sound-sensing device 164 are transmitted to media-delivery system 104 (or another external server) for analysis using speech-recognition and/or intent-recognition technologies. As discussed above, in some embodiments, recordings captured by the sound-sensing device 164 may be used to help determine what type of environment a piece of music is being played in.

The optical-sensing device 166 senses optical signals proximate the media-playback device 102. In some embodiments, the optical-sensing device 166 comprises one or more light sensors or cameras. For example, the optical-sensing device 166 may capture images or videos. The captured images can be processed (by the media-playback device 102 or an external server such as the media-delivery system 104 to which the images are transmitted) to detect gestures, which may then be interpreted as commands to change the playback of media content. Similarly, a light sensor can be used to determine various properties of the environment proximate the user computing device, such as the brightness and primary frequency (or color or warmth) of the light in the environment proximate the media-playback device 102. These properties of the sensed light may then be used to infer whether the media-playback device 102 is in an indoor environment, an outdoor environment, a private vehicle, public transit, etc. Again, in some embodiments, optical signals captured by the optical-sensing device 166 may be used to help determine what type of environment a piece of music is being played in.

The media-delivery system 104 comprises one or more computing devices and provides media content items to the media-playback device 102 and, in some embodiments, other media-playback devices as well. The media-delivery system 104 includes a media server 180. Although FIG. 2 shows a single media server 180, some embodiments include multiple media servers. In these embodiments, each of the multiple media servers may be identical or similar and may provide similar functionality (e.g., to provide greater capacity and redundancy, or to provide services from multiple geographic locations). Alternatively, in these embodiments, some of the multiple media servers may perform specialized functions to provide specialized services (e.g., services to enhance media content playback during travel or other activities, etc.). Various combinations thereof are possible as well.

The media server 180 transmits stream media 218 to media-playback devices, such as the media-playback device 102. In some embodiments, the media server 180 includes a media server application 184, a multiple masters server application 220, a processing device 188, a memory device 190, and a network access device 192. The processing device 188, memory device 190, and network access device 192 may be similar to the processing device 154, memory device 156, and network access device 162, respectively, which have each been previously described.

In some embodiments, the media server application 184 streams music or other audio, video, or other forms of media content. The media server application 184 includes a media stream service 194, a media data store 196, and a media application interface 198. The media stream service 194 operates to buffer media content, such as media content items 206, 208, and 210, for streaming to one or more streams 200, 202, and 204.

The media application interface 198 can receive requests or other communication from media-playback devices or other systems, to retrieve media content items from the media server 180. For example, in FIG. 2, the media application interface 198 receives communication 234 from the media-playback engine 170.

In some embodiments, the media data store 196 stores media content items 212, media content metadata 214, and playlists 216. The media data store 196 may comprise one or more databases and file systems. As noted above, the media content items 212 may be audio, video, or any other type of media content, which may be stored in any format for storing media content. In some embodiments, the media data store 196 may store multiple master versions of a piece of music, which may be manually or automatically selected, via the multiple masters engine 108.

The media content metadata 214 operates to provide various information associated with the media content items 212. In some embodiments, the media content metadata 214 includes one or more of title, artist name, album name, length, genre, mood, era, etc. The playlists 216 operate to identify one or more of the media content items 212 and. In some embodiments, the playlists 216 identify a group of the media content items 212 in a particular order. In other embodiments, the playlists 216 merely identify a group of the media content items 212 without specifying a particular order. Some, but not necessarily all, of the media content items 212 included in a particular one of the playlists 216 are associated with a common characteristic such as a common genre, mood, or era. The playlists 216 may include user-created playlists, which may be available to a particular user, a group of users, or to the public.

In some embodiments, the media server 180 includes a multiple masters server application 220. In some embodiments, the multiple masters server application 220 includes a multiple masters interface 228 and a multiple masters media metadata store 230. In some embodiments, the multiple masters server application 220 may provide information to a media-playback device indicating that multiple master versions of a song are available and/or provide a list of the multiple available master versions of the song to the media-playback device.

The multiple masters interface 228 operates to receive requests or other communication from media-playback devices or other systems to retrieve information about media content items from the media server 180. For example, in FIG. 2, the multiple masters interface 228 receives communication 236 from the media-playback engine 170.

In some embodiments, the multiple masters media metadata store 230 stores multiple masters media metadata 232. The multiple masters media metadata store 230 may comprise one or more databases and file systems. Other embodiments are possible as well. The multiple masters media metadata 232 operates to provide various information associated with media content items, such as the media content items 212. In some embodiments, the multiple masters media metadata 232 provides information that may be useful for selecting media content items for playback. For example, in some embodiments, the multiple masters media metadata 232 stores descriptive tags, names, numbers or similar information that describes each different master version of a song. As another example, in some embodiments, the multiple masters media metadata 232 stores equalizer settings that can be provided to the playback device 102 to generate new master versions of a song.

Each of the media-playback device 102 and the media-delivery system 104 can include additional physical computer or hardware resources. In at least some embodiments, the media-playback device 102 communicates with the media-delivery system 104 via the network 106.

Although in FIG. 2 only a single media-playback device 102 and media-delivery system 104 are shown, in accordance with some embodiments, the media-delivery system 104 can support the simultaneous use of multiple media-playback devices, and the media-playback device can simultaneously access media content from multiple media-delivery systems. Additionally, although FIG. 2 illustrates a streaming media based system for media playback during travel, other embodiments are possible as well. For example, in some embodiments, the media-playback device 102 includes a media data store 196 and the media-playback device 102 is configured to select and playback media content items without accessing the media-delivery system 104. Further in some embodiments, the media-playback device 102 operates to store previously streamed media content items in a local media data store (e.g., the media content cache 172).

In at least some embodiments, the media-delivery system 104 can be used to stream, progressively download, or otherwise communicate music, other audio, video, or other forms of media content items to the media-playback device 102 for playback during travel on the media-playback device 102. In accordance with an embodiment, a user U can direct the input 176 to the user interface 168 to issue requests, for example, to playback media content for playback during travel on the media-playback device 102.

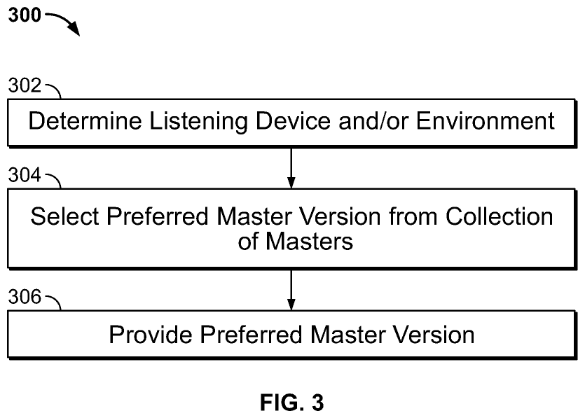

FIG. 3 illustrates an example method 300 of providing a master version of a piece of music, selected from a collection of multiple master versions, using the multiple masters engine 108. This example method 300 may be referred to generally as an “automatic method.” In this embodiment, the multiple masters engine 108 is configured to: (1) determine a type of device the listener is using to listen to music and/or an environment in which the listener is listening to music 302; (2) automatically select, based on the determination, a preferred master version of the piece of music from a collection of multiple available master versions of the piece of music 304; and (3) provide the selected master version to the listener 306.

Multiple master versions of any piece of music accessed by the multiple masters engine 108 may be stored in a database, such as the media data store 196, in the cloud, in the media content cache 172, etc. Any number and type of master versions may be stored and made available to a listener. For example, some master versions of a song may be made specifically for one type of playback device, other masters may be made specifically for one type of listening environment, and other masters may be made for a specific combination of type of listening device and type of environment. Just a few examples of such master versions may include, but are not limited to, mastered for high fidelity (or “HiFi”), mastered for binaural (or “3D”), mastered for on the go, mastered for travel, mastered for noisy environment, mastered for normal environment, or mastered for quiet environment, mastered for ear buds, mastered for high fidelity headphones, mastered for car stereo, mastered for outdoor activities, mastered for high compression, and mastered for low compression. Other master versions might be even more specific, such as “mastered for high fidelity sound system in quiet listening room,” “mastered for ear buds while running outdoors,” “mastered for HiFi headphones in binaural” or “mastered for car stereo in noisy driving conditions.”

The number and type of master versions of a given piece of music are basically limitless, and all types and combinations of master versions of songs are contemplated within the scope of this application. The multiple master versions of a given piece of music may be purchased from a recording studio or other provider of content and may be stored in the cloud, in a database, such as the media data store 196, or the like. The multiple masters may be provided to the listener via any of a number of different methods, such as by a streaming music subscription service. In some cases, a listener may pay extra to have access to multiple master versions of songs, while in other cases access may be provided as part of a standard package of music. Some of these configurations will be described further below.

Each master version of a piece of music will have certain characteristics, designed to make that version pleasurable to listen to in a specific environment and/or with a specific listening device. For example, a “Mastered for HiFi” master version might be optimized for listening in a quiet music room over a high fidelity sound system or with high fidelity headphones. The Mastered for HiFi version might have a very high dynamic range and very little compression. In another example, a “Mastered for Binaural” or “Mastered for 3D” master version may be mastered specifically for listening on headphones, since binaural only works with headphones. In yet another example, a “Mastered for On the Go” version might be designed for listening while walking or working, when the listening device is standard, low-quality ear buds. This Mastered for On the Go version might have relatively less dynamic range and more compression than the Mastered for HiFi version. In yet another example, a “Mastered for Travel” version of the same piece of music might be designed for listening in a noisy environment, such as in a car or subway. This version might have even lower dynamic range and higher compression than the “Mastered for On the Go” version. Again, as mentioned above, any number and type of master versions of a piece of music may be made available, according to various embodiments.

In some embodiments, multiple master versions of a piece of music are stored in a database or other location, with a tag or label for each version, describing what type of master it is. These tags may be word descriptions, such as “Mastered for HiFi,” “Mastered for Binaural,” “Mastered for On the Go,” “Mastered for Travel,” or others listed immediately above. In alternative embodiments, the tags may be numeric descriptions based on a master version numbering system or any other types of tags. The tags may be provided to a user on an interface in some embodiments, as described further below.

In the first step of the playback method 300, the system determines what type of listening device is being used to listen to the media content, what type of environment the listener is in, or both 302. In various embodiments, one or more different components of the media-playback system 100 may be used to help determine what type of device the listener is using to play back the media content and/or what type of environment the listener is in 302. In one embodiment, for example, a playback device or other part of the media-playback system 100 may detect when a listener plugs headphones into a headphone jack (or USB-3 port, lightning port or the like) or pairs Bluetooth headphones with a Bluetooth-enabled playback device. In fact, in some embodiments, the system 100 may determine not only that headphones have been connected, but also more specific information about what type of headphones have been connected (wirelessly or via headphone jack)—e.g., ear buds vs. HiFi headphones, quality level of the headphones, exact make and model of headphones, etc.

When the system 100 has determined a listening device, such as headphones (or a specific type of headphones), that is being used for listening 302, the system 100 may then automatically select (in the automatic embodiment) a preferred master version of the song from a collection of master versions 304 and provide that version to the listener 306. In some embodiments, the preferred master version is obtained from a lookup table. In some embodiments, the lookup table includes a list of listening devices and identifies the preferred master version for each of the listening devices. In another possible embodiment, the lookup table includes a list of available master versions and includes selection criteria that can be used by the system 100 to determine which of the master versions is best suited to the listening device being used for listening. In another possible non-automated embodiment, a menu is presented to the user, including a list of available master recordings and including a description, including at least some of the selection criteria that can be used by the user to determine the best master version.

One type of master version that the system 100 may select to play back, for example, is a “Mastered for Noisy Environments” version. This might be chosen, if the system 100 determines that low-quality earbuds are being used for listening and/or if the system 100 determines, for example via a microphone on the playback device, that the media is being listened to in a noisy environment. Another type of master that might be automatically chosen is a “Mastered for Binaural” or “Mastered for 3D” version. This type of master version is specifically designed for headphones, since only headphones are able to provide binaural listening. In contrast to these examples, if the system 100 determines that the listener is connecting to a HiFi speaker, rather than headphones, the system 100 may selected a “Mastered for HiFi Speakers” master version of the song.

In another example, the location-determining device 150 of the system 100 may be used, in some embodiments, to help determine what the listening environment is. The sound-sensing device 164, such as a microphone, may also be used for this purpose, for example to determine if the environment is noisy, quiet or in between. In these or other embodiments, the optical-sensing device 166, such as a camera, may be used to capture an image of the environment to help make the determination. The movement-detecting device 160 may similarly be used to determine whether the listener is on the go, running, engaging in other physical activity, etc. Any of these devices and/or other devices may be used by the system 100 to help determine what type of device the listener is using and/or what type of environment the listener is in. For example, if the system 100 determines that the media-playback device 102 is operating in a low noise environment with mid-level quality ear buds, the multiple masters engine 108 may select an “On the Go” master version of a song. If the system 100 determines that the media-playback device 102 is operating in a noisy car, the multiple masters engine 108 may select a “Travel” master version of a song.

In some embodiments, the media-playback device 102 determines that it is connected to a vehicle media-playback system, based on a Bluetooth-device identifier associated with a device to which it is connected. In some embodiments, the media-playback device 102 determines that it is travelling, based on detecting movement of the media-playback device (e.g., based on the location-determining device and/or the movement-detecting device). For example, some embodiments determine that media-playback device 102 is travelling when the movement-detecting device detects an acceleration that exceeds a pre-determined threshold. Similarly, some embodiments determine that the media-playback device 102 is travelling based on determining that the media-playback device is a moving at a speed that exceeds a predetermined threshold (e.g., as determined by a series of measurements by the movement determining device). This is merely one example.

In some embodiments, the method 300 may include one or more additional, optional steps. For example, in some embodiments it may be possible to switch master versions of a piece of music while the song is playing. This may be done automatically in some embodiments and manually in others. For example, after the initial preferred master version of the song is provided 306, the media playback system 100 may determine that the listening environment has changed, thus essentially returning to step 304 of FIG. 3. A new master version of the song might then be automatically selected and provided to the listener, sometimes during playback of the song. For example, if a piece of music is being played in the car, a Mastered for Travel version of a song might have been initially selected using the method 300, while the car was driving down the freeway or in an otherwise noisy background environment. When the car stops, for example at a traffic light, the master version may switch to a Mastered for Quiet version, for example, if the noise level is significantly less than during driving. When the car starts driving again, the audio playback may switch back to the Mastered for Travel version. In some embodiments, this type of master version switching may occur any number of times during a song playback. In other embodiments, switching during a song may be an optional feature, which may be manually turned on or off by the listener, for example if a listener does not like switching between masters during playback.

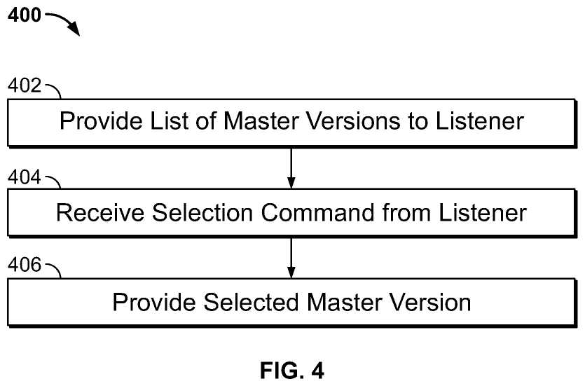

Referring now to FIG. 4, in an alternative embodiment, a method for providing multiple master versions of a song to a listener 400 may involve: (1) providing a list of multiple master versions of the piece of music to a listener 402; (2) receiving a command from the listener, selecting a master version from the list of multiple master versions 404; and (3) providing the selected master version to the listener 406. This method 400 may be generally referred to as a “manual method,” since the user selects the preferred master version. In some embodiments, some or all of the steps may be repeated, for example if the user indicates a desire to switch to a different master version of a piece of music during playback.

In some embodiments, the multiple masters engine 108 may use a hybrid approach for providing multiple master versions of a piece of music to a listener. A hybrid approach may include some aspects of the automatic method 300 and the manual method 400. For example, in some embodiments the automatic method 300 may be used initially to select a particular master version of a song, based on a type of device and/or environment, and the listener may also be given the option to manually select a master from a list of multiple masters. The listener selected master version will override the automatically selected version. Or the listener may be given the option, when a song is listed, to either manually select a master version from a list of masters or to have the master version automatically selected by the multiple masters engine 108. In yet another embodiment, the listener may first choose a master version manually, and then the multiple masters engine 108 may suggest an alternative master version, perhaps based on the determination by the multiple masters engine 108 that a different master version might sound better in a given environment and/or on a given playback device. Any of these features or combinations of features, as well as any other suitable hybrid approach to selecting master versions, are contemplated within the scope of this disclosure.

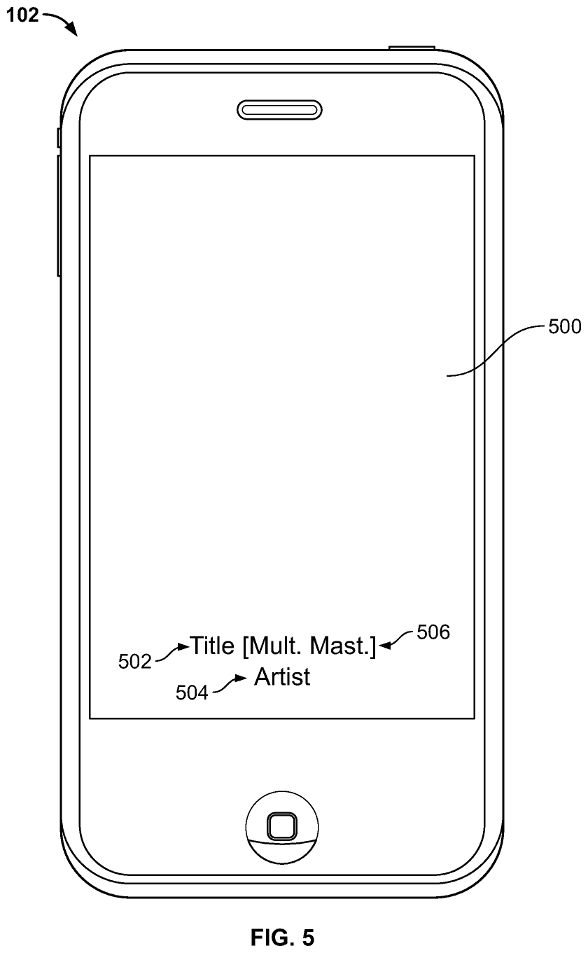

With reference now to FIG. 5, whether operating in automatic, manual, or hybrid mode, the multiple masters interface 228 may be configured to generate one or more interfaces with information relating to the multiple master versions of the piece of music. Such interfaces are likely most important in embodiments of the manual method 400, where the listener manually selects the preferred master version, since the listener will need to have some way to know that multiple master versions are available and what type of versions are available. The listener will also need to have a way to select the desired master version from the collection of multiple versions. However, one or more interfaces may also be provided as part of the automatic method 300 or a hybrid method.

Referring to FIG. 5, in one embodiment the media playback device 102 may include an interface 500 that shows a song title 502, the name of the artist 504 that recorded the song, and a multiple masters indicator 506. In some embodiments, the multiple masters indicator 506 may be similar to the designation [Explicit] or [Explicit Lyrics], which is used to label some songs. Any combination of words, letters or symbols may be used, such as but not limited to [Multiple Masters Available], [Multiple Masters], [Mult. Mast.], [MM] or the like. Furthermore, brackets are not necessary but are shown here for exemplary purposes only. Parentheses may be used, or no bracketing symbols at all may be used. In another embodiment, the multiple masters indicator 506 may simply be a number. For example, the number “3” after a song title may be used to indicate that three master versions of the song are available. In yet another embodiment, a combination of numbers and letters may be used, such as “MM 3” for example.

In some embodiments, the interface 500 may allow the listener to perform one or more different selections. For example, in one embodiment, the listener may have the option to simply select the song, without selecting a particular master version. This may be the case if the listener does not have time to select a master version or does not care which version is played. In this embodiment, the multiple masters engine 108 may either select a specific master version, using the automatic method 300, or it may choose a default master version. If, on the other hand, the listener does want to choose the master version, she may select “Multiple Masters,” for example by touching the interface 500 at the area of the multiple masters indicator 506. At this point, the multiple masters engine 108 will provide the listener with a list of master versions to choose from.

Although the interface 500 is shown as a visual display in FIG. 5, optionally with a touch screen for allowing the listener to input selections via touch, the interface may additionally or alternatively take any other suitable form. For example, in some embodiments, the media playback device 102 may use spoken cues to tell the user that multiple master versions are available and may accept voice commands from the listener to select the desired master version of a piece of music. In some embodiments, the listener may have the choice of using visual indicators and touch commands or voice indicators and commands.

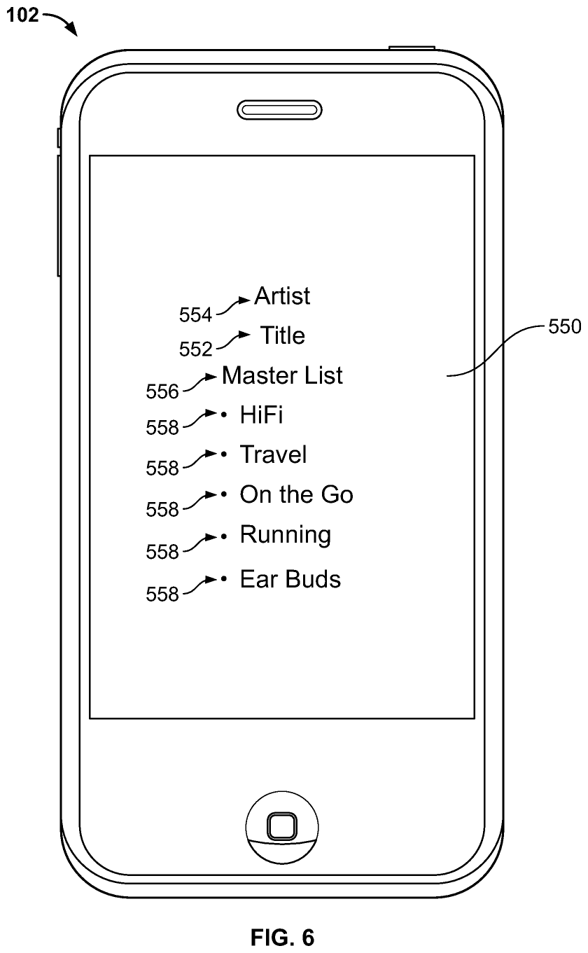

Referring now to FIG. 6, in some embodiments, a master list interface 550 may be generated by the multiple masters engine. The master list interface 550 may be used instead of the interface 500 of FIG. 5 or may alternatively be shown to the listener after the listener indicates (on the interface 500 or otherwise) that he wants to select a master version from the multiple masters list. In other words, in some embodiments the interface 500 might not be used, and instead the listener may simply be provided with the master list interface 550. The master list interface 550 may include an artist name 554, a song title 552, a “master list” heading 556, and a list of multiple master versions 558, which the listener can choose from. Again, the listener may choose a specific master version 558 using either touch or voice commands, according to some embodiments. In the embodiment shown, the available master versions 558 are HiFi, Travel, On the Go, Running and Ear Buds, but these are provided for exemplary purposes only, and any number or combination of master versions 558 may be provided in alternative embodiments. When the listener selects a preferred master version 558, that version of the song starts to play.

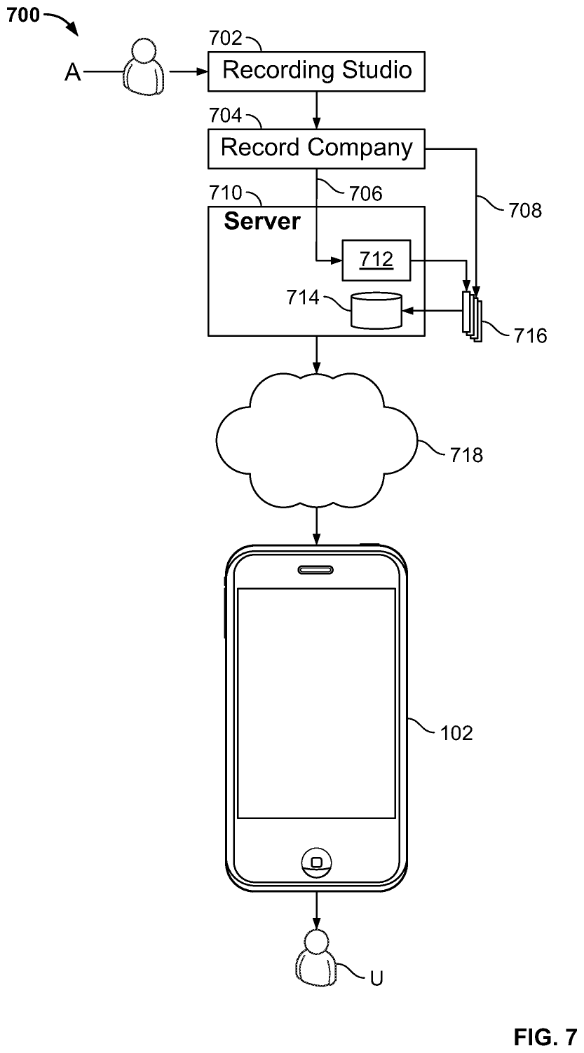

Referring now to FIG. 7, an overall music delivery system 700 and data flow are illustrated, according to one embodiment. Recorded music is typically recorded by an artist A in a recording studio 702, although alternatively it may be recorded in a live music venue, a home recording studio or any other suitable location. The recording studio 702 may create one master version of any given song or may create multiple master versions. The recording studio 702 then provides the recorded master version(s) to a record company 704. In some embodiments, the provided music might be in the form of only one master version in raw format, and the recording studio 702 might provide the record company 704 with instructions (or “multiple masters mixing data”), which will allow the record company 704 to create multiple master versions.

Next, the record company 704 may provide either a single file 706 for each song (such as but not limited to an MP3 file) or multiple master files 708 for each song to a streaming music service, via a server 710. The server 710 may include a multiple masters generator 712, such as a processor with instructions for using multiple masters mixing data to generated multiple master versions from an original single master version. Whether originating from the record company 704 or the multiple masters generator 712, multiple master versions 716 of a song may be provided and stored in a database 714 on the server 710. When the server 710 receives a request for a song from, it sends the media content through the cloud 718 to the playback device 102, and the song is played back for the user U.

This description of the system 700 is simplified, and any number of variations may be made, according to various alternative embodiments. For example, in different embodiments, master versions of a song may be generated at different locations (and using different mechanisms) along the system 700. For example, as mentioned above, multiple master versions may be made by the recording studio 702 in some embodiments, by the record company 704 in other embodiments, by a streaming music service or a processor owned and controlled by some other entity in other embodiments, and even by an equalizer on an audio player in other embodiments. Equalizer instructions may be used, for example, to make a song more or less dynamic, more or less compressed, adjust treble, bass, or any other musical tonality, enhance specific instruments within a musical piece (drums, guitar, keyboard, etc.), or any other suitable adjustment.

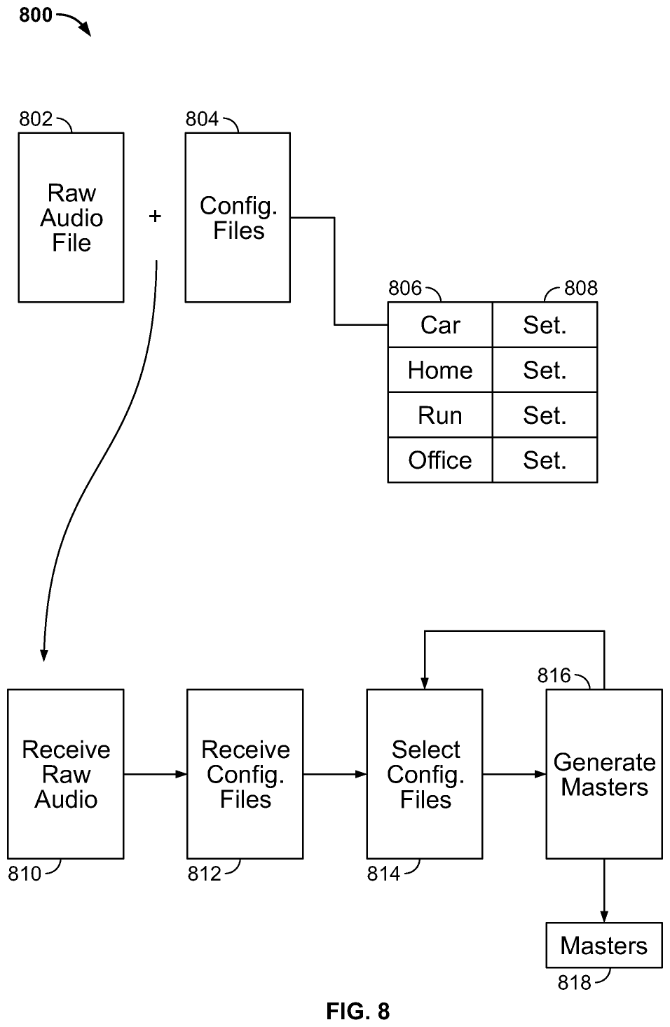

FIG. 8 illustrates one exemplary embodiment of a master generation method 800. Although the method 800 is described here in the context of one song, the method 800 may be extrapolated to cover multiple songs. In this embodiment, a raw audio file 802 may be provided to a user (a streaming audio service, for example), along with one or more configuration files 804 (or “config files”). The config files 804 may include data to instruct a masters generator to produce multiple master versions of a song from the raw audio file 802. For example, as illustrated, the config files 804 may include multiple different sets 808 of equalizer settings (or “master generation settings”), with each set 808 corresponding to a specific environment 806, a specific media player, or an environment/player combination.

The streaming audio service or other user may receive the raw audio data 810, receive the config files 812, select one of the config files 814, and generate a master version of the song 816. The selecting step 814 and generating step 816 may be repeated as many times as desired, to create as many master versions 818 as desired (or as possible, given the available config files 804). Again, this method 800 may be performed by any of a number of different entities, including a music streaming service, a record company, and even a stereo system or other music system designed to perform the various steps.

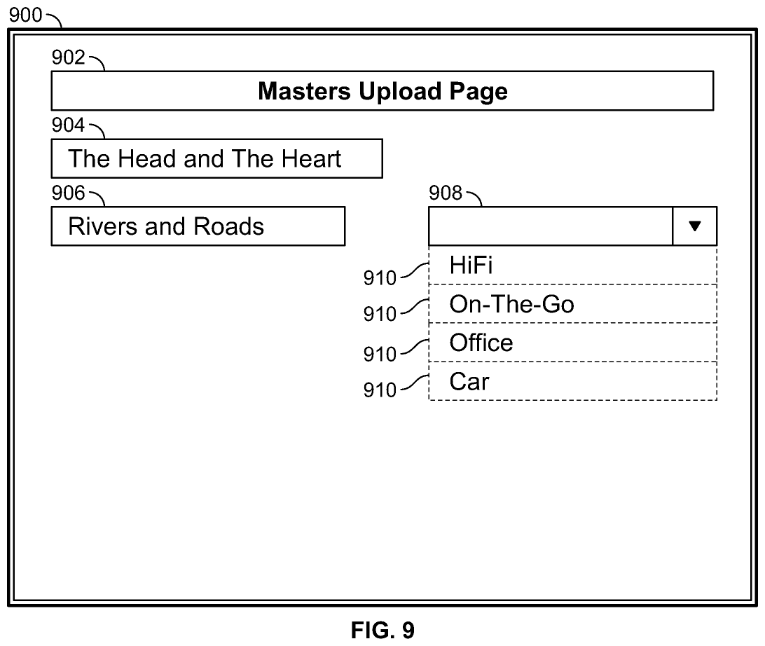

With reference now to FIG. 9, a music upload user interface 900 is illustrated, according to one embodiment. The user interface 900 is intended for a user that uploads music onto a server for playback or sale to listeners, such as but not limited to a streaming music service, record company or the like. The user interface 900 is used to interface with a music content provider, in order to select master versions of a song to upload to the server. In this embodiment, the user interface 900 includes a banner 902, here shown as “Master Upload Page,” but alternatively any other words, art or symbols could be included, or the banner 902 could be eliminated from the interface 900 without affecting function. The user interface 900 may also include an artist display 904, here showing the example of the band The Head and the Heart. The user interface 900 may also include a song title display 906, here shown as the song “Rivers and Roads.” To the right of the song title display 906 is a drop down menu 908, which, when selected, displays multiple different master versions 910 of the song—HiFi, On-the-Go, Office and Car, in this example. The user may select one or more of the master versions 910 to upload to the server. This embodiment of the user interface 900 is merely one example of a mechanism for allowing a music service to access and upload music from a recording studio or other provider of recorded music.

During the upload process 900 (or before or after this process, in various embodiments), each master version of a particular song may be tagged or labeled with a unique identifier (or “tag”), which identifies the song and the master version. In some embodiments, the labeling may involve two steps and/or two tags for each song—i.e., a tag identifying the song, and a tag identifying the particular master version of the song. In some embodiments, the tag may simply be one number, which identifies the song and what master version it is. Any combination of letters, numbers, symbols or other tags may be used.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of providing a piece of music to a listener, the method comprising:
determining at least one of a type of device the listener is using to listen to music or an environment in which the listener is listening to music;
automatically selecting, based on the determining step, a preferred master version of the piece of music from a collection of multiple available master versions of the piece of music stored in a database; and
providing the preferred master version of the piece of music to the listener on the device.

2. The method of claim 1, further comprising displaying a list, to the listener, of the multiple available master versions of the piece of music.

3. The method of claim 2, further comprising:
receiving, from the user, an override command designating a different one of the multiple available master versions, other than the preferred master version; and
providing the different one of the multiple available master versions to the listener on the device.

4. The method of claim 2, wherein the list of the multiple available master versions includes at least one of mastered for high fidelity, mastered for binaural, mastered for 3D, mastered for on the go, mastered for travel, mastered for noisy environment, mastered for normal environment, or mastered for quiet environment, mastered for ear buds, mastered for high fidelity headphones, mastered for car stereo, mastered for outdoor activities, mastered for high compression, or mastered for low compression.

5. The method of claim 2, further comprising displaying, near a title of the piece of music, a display indicating that multiple master versions of the piece of music are available.

6. The method of claim 1, wherein the determining step comprises listening to the environment in which the listener is listening to music using a microphone on or near the device to determine how noisy the environment is.

7. The method of claim 1, wherein the determining step comprises capturing an image of the environment in which the listener is listening to music using a camera on or near the device to determine what type of environment the environment is.

8. The method of claim 1, wherein the determining step comprises determining whether digital information is available describing the device.

9. The method of claim 1, wherein the determining step comprises determining that the device has been connected with headphones, and wherein the selected preferred master version is selected from the group consisting of mastered for binaural and mastered for 3D.

10. The method of claim 1, further comprising switching from the preferred master version to a different master version during playback of the piece of music, based on the environment changing during the playback.

11. The method of claim 10, further comprising switching back to the preferred master version during playback of the piece of music, based on the environment changing again.

12. The method of claim 10, wherein automatically selecting the preferred master version comprises obtaining the preferred master version from a lookup table.

13. The method of claim 12, wherein the lookup table comprises a list of multiple listening devices, and wherein automatically selecting the preferred master version comprises identifying the preferred master version for each of the multiple listening devices.

14. The method of claim 12, wherein the lookup table comprises a list of available master versions and wherein automatically selecting the preferred master version comprises using selection criteria to determine which of the available master versions is best suited to a listening device being used for listening.

15. The method of claim 1, further comprising:
receiving a single original master version of the piece of music from a provider of music;
generating the collection of multiple available master versions from the single original master version; and
storing the collection in memory on a server.

16. The method of claim 15, further comprising receiving a configuration file from the provider of music, wherein the configuration file includes data describing a method for generating the collection of multiple master versions from the single original master version, and wherein the generating step includes using the configuration file to generate the collection of multiple master versions.

17. A method of providing a piece of music to a listener, the method comprising:
providing a list of multiple master versions of the piece of music to the listener, wherein the multiple master versions are stored in a database;
receiving a first command from the listener, selecting a first master version from the list of multiple master versions; and
providing the first master version of the piece of music to the listener.

18. The method of claim 17, wherein the list of the multiple available master versions includes at least one of mastered for high fidelity, mastered for binaural, mastered for 3D, mastered for on the go, mastered for travel, mastered for noisy environment, mastered for normal environment, or mastered for quiet environment, mastered for ear buds, mastered for high fidelity headphones, mastered for car stereo, mastered for outdoor activities, mastered for high compression, or mastered for low compression.

19. The method of claim 17, further comprising displaying, near a title of the piece of music, a display indicating that multiple master versions of the piece of music are available.

20. The method of claim 17, further comprising:
receiving a second command from the listener, selecting a second master version from the list of multiple master versions; and
providing the second master version of the piece of music to the listener.

21. The method of claim 20, wherein the second master version is selected and provided during playback of the piece of music.

22. The method of claim 17, further comprising:
receiving a single original master version of the piece of music from a provider of music;
generating the collection of multiple available master versions from the single original master version; and
storing the collection in memory on a server.

23. The method of claim 22, further comprising receiving a configuration file from the provider of music, wherein the configuration file includes data describing a method for generating the collection of multiple master versions from the single original master version, and wherein the generating step includes using the configuration file to generate the collection of multiple master versions.

24. A media playback device, comprising:
an audio output device for media playback;
a touch-sensitive display;
a processor;
a computer-readable storage device storing data instructions, which, when executed by the processor, cause the processor to:
display a list of multiple master versions of a piece of music to a listener on the touch-sensitive display;
receive an instruction from the listener, selecting a first master version of the multiple master versions for playback on the device; and
play the first master version of the piece of music on the media playback device.

25. The device of claim 24, wherein the instructions further cause the processor to:
determine an environment in which the listener is listening to music;
automatically select, based on the determining step, a second master version of the multiple master versions; and
provide the second master version of the piece of music on the media playback device to the listener.

26. The device of claim 25, wherein the second master version is provided to the listener on the touch-sensitive display as a suggested alternative master version.

27. The device of claim 25, wherein the instructions further cause the processor to switch from the second master version to the first master version or a third master version during playback of the piece of music, based on the environment changing during the playback.

28. The device of claim 27, wherein the instructions further cause the processor to switch back to the second master version during playback of the piece of music, based on the environment changing again.

29. The device of claim 24, wherein the instructions further cause the processor to display a list, on the touch-sensitive display, of the multiple available master versions of the piece of music.

30. The device of claim 29, wherein the list of the multiple available master versions includes at least one of mastered for high fidelity, mastered for binaural, mastered for 3D, mastered for on the go, mastered for travel, mastered for noisy environment, mastered for normal environment, or mastered for quiet environment, mastered for ear buds, mastered for high fidelity headphones, mastered for car stereo, mastered for outdoor activities, mastered for high compression, or mastered for low compression.

31. The device of claim 30, wherein the instructions further cause the processor to display, near a title of the piece of music, a display indicating that multiple master versions of the piece of music are available.

32. The device of claim 24, wherein the instructions cause the processor to receive an instruction from the listener via an entry on the touch-screen display.
